(19) United States
(12) Patent Application Publication
(10) Pub. No.: US 2021/0203023 A1
(43) Pub. Date: Jul. 1, 2021

(54) AN ELECTROCHEMICAL CELL AND METHOD OF MAKING THE SAME

(71) Applicant: AGENCY FOR SCIENCE, TECHNOLOGY AND RESEARCH, Singapore (SG)

(72) Inventors: Mein Jin TAN, Singapore (SG); Bing LI, Singapore (SG); Xian Jun LOH, Singapore (SG); Yun ZONG, Singapore (SG); Zhao LIU, Singapore (SG); Xiao Ming GE, Singapore (SG)

(21) Appl. No.: 16/090,163

(22) PCT Filed: Mar. 29, 2017
(86) PCT No.: PCT/SG2017/050171

§ 371 Date: Sep. 28, 2018

(30) Foreign Application Priority Data
Mar. 29, 2016 (SG) 10201602459U

(51) Int. Cl. H01M 12/02; H01M 12/08; H01M 4/38; H01M 4/86; H01M 4/90; H01M 4/96; H01G 9/042; H01G 13/00; H01G 9/035

(52) U.S. Cl. CPC H01M 12/02; H01M 12/08; H01M 4/38; H01M 4/8652; H01M 2004/027; H01M 4/96; H01G 9/0425; H01G 13/00; H01G 9/035; H01M 4/9016

(57) ABSTRACT

This invention relates to an electrochemical cell comprising an anode structure comprising an element selected from the group consisting of group 1, group 2, group 8, group 12 and group 13 of the Periodic Table of Elements; a cathode structure comprising a catalyst; and a hydrogel located between the anode structure and the cathode structure. In a preferred embodiment, the cell comprises the anode of Zinc, the catalyst of CoOx/C, the hydrogel of free-standing alkaline polyacrylamide hydrogel, wherein said hydrogel was first synthesized via UV-initiated radical polymerization of acrylamides, followed by exchange of water with an alkaline electrolyte of potassium hydroxide (KOH). The invention further relates to a method of manufacturing such an electrochemical cell and the use of a hydrogel in a metal/air battery.

### TECHNICAL FIELD

The present invention relates to an electrochemical cell that comprises a free-standing film for energy storage. The present invention also relates to a method for preparing such an electrochemical cell, and the use of a hydrogel for use in a zinc/air battery.

### BACKGROUND ART

Energy management is one of the biggest challenges mankind is facing now and that which will need to be tackled in the future. Research into alternative, renewable energy generation technologies (such as solar and wind) have gathered much interest in recent years, and is expected to grow further due to the projected decrease in fossil-based resources. However, one of the drawbacks that limit the wide-scale adoption of technologies in renewable energy is the ability to store the excess energy generated for future use. As such, energy storage also plays an integral part of the energy management landscape.

Among the energy storage technologies currently available, zinc/air batteries (Zn-ABs) offer very high theoretical energy density (up to 6091 Wh L⁻¹, about 6 times as much as today's best Li-ion technology), is relatively cheap (by using abundant resources such as zinc and air/oxygen as electrode materials) and is considered safer than lithium-based counterparts because of the use of aqueous-based electrolytes as opposed to flammable organic solvents. However, a major disadvantage of Zn-ABs is the rather short lifetime of Zn-ABs due to the evaporation and leakage of the aqueous electrolyte (usually alkaline-solutions such as potassium hydroxide (KOH)). Although stringent packaging techniques have sought to circumvent this problem, it is far from an ideal solution, particularly as it limits application in areas where mechanical flexibility is required.

Polymer gel electrolytes (PGEs) have emerged as an alternative solution, greatly reducing the rate of evaporation of the electrolyte as well as being able to confer a level of “mechanical viability” that enables it to be handled like a solid. Some early examples of PGEs include polyvinyl alcohol (PVA), polyethylene oxide (PEO) and polyacrylic acid (PAA). While these materials maintain reasonable ionic conductivity and limit the evaporation of the electrolyte, they require either an additional support matrix such as a glass-fibre-mat or must be incorporated into multi-component PGEs to have sufficient mechanical stability to function as a free-standing film.

There is therefore a need to provide an electrochemical cell that overcomes or at least ameliorates, one or more of the disadvantages described above.

### SUMMARY

In an aspect, there is provided an electrochemical cell comprising:
an anode structure comprising an element selected from the group consisting of group 1, group 2, group 8, group 12 and group 13 of the Periodic Table of Elements;
a cathode structure comprising a catalyst; and
a hydrogel located between the anode structure and the cathode structure, wherein the hydrogel comprises water and a cross-linked polymer having repeating units of the following formula (I):

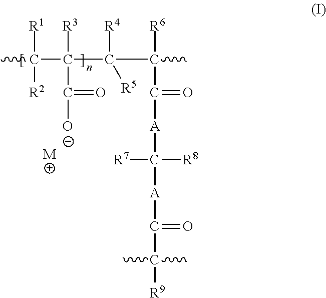

wherein A is selected from the group consisting of —NH—, —C(O)O—, —OC(O)—, and —C(O)NR¹⁰C(O)—;
R¹, R², R³, R⁴, R⁵, R⁶, R⁷, R⁸, R⁹ and R¹⁰ are independently selected from the group consisting of hydrogen, optionally substituted alkyl, optionally substituted alkenyl and optionally substituted alkenyl;
M is an alkali metal;
n is an integer of at least 1; and
the wavy line (˜˜˜) indicates the point of attachment to other repeating units of Formula (I).

Advantageously, the cross-linked polymer in the hydrogel may be highly cross-linked (that is, it may have a number of repeating units in the range of about 50 to about 50,000 or a degree of cross-linking in the range of about 20 mol % to about 80 mol %. By being a highly cross-linked polymer, the hydrogel may be mechanically strong, having high tensile strength, elastic modulus, stress at break and strain at break measurement values, and may be able to be free-standing without the need to add additives or strengthening agents to the hydrogel. Hence, the hydrogel may optionally exclude the presence of mechanically strengthening agents such as glass fiber cloth.

In addition, due to the highly cross-linked nature of the polymer hydrogel, a greater number of M+O— can be absorbed by the cross-linked polymer, thus increasing the alkalinity of the hydrogel. Further, the cross-linked structure of the polymer may facilitate swelling of the polymer which in turn may allow for faster transport of OH— ions to facilitate battery reaction. Due to the cross-linked structure of the polymer in the hydrogel, it is to be noted that the polymer in the hydrogel does not have a linear structure.

The hydrogel further does not require further copolymerization or additional components in order to function as a polymer gel electrolyte. Further advantageously, the disclosed electrochemical cell may be used for traditional solid state Zn/air batteries and advanced solid-state bendable zinc/air batteries.

Advantageously, the disclosed electrochemical cells may be assembled into coin cell type Zn/air batteries. Further advantageously, these batteries may show superior discharge and cycling ability. Advantageously, the disclosed electrochemical cells may have high energy storage capacity.

Advantageously, the hydrogel in the disclosed electrochemical cell is highly stable. This is in contrast to conventional hydrogels that are commonly known to collapse in the presence of high ionic strength which would not be suitable as the electrolyte of Zn/air batteries. Advantageously, the hydrogel in the disclosed electrochemical cell remains as a stable gel in the presence of high ionic strength and at high pH.

Further advantageously, the solid state nature of the electrochemical cell may circumvent the issues of conventional electronic cells which comprise a fluid aqueous electrolyte, thereby allowing the electrochemical cell to avoid or reduce problems such as displacement of the liquid electrolyte during operation. In addition, the solid state nature advantageously enables the electrochemical cell to have mechanical flexibility, therefore allowing the cells to be expandable/compressible. In addition, due to the sold-state nature of the electrochemical cell, the disclosed electrochemical cell can circumvent the issue of solvent evaporation from the liquid electrolyte.

Free standing alkaline polymer gel electrolyte films may be used to enable stable operation of Zn-AB cells of different forms, such as bendable all solid-state Zn-ABs, and compressible/expandable Zn-Abs.

In another aspect, there is provided a method for manufacturing an electrochemical cell, the method comprising the steps of:
providing a hydrogel comprising water and a cross-linked polymer having repeating units of the following formula (I):

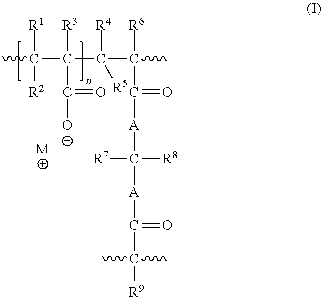

wherein A is selected from the group consisting of —NH—, —C(O)O—, —OC(O)—, and —C(O)NR¹⁰C(O)—;
R¹, R², R³, R⁴, R⁵, R⁶, R⁷, R⁸, R⁹ and R¹⁰ are independently selected from the group consisting of hydrogen, optionally substituted alkyl, optionally substituted alkenyl and optionally substituted alkenyl;
M is an alkali metal;
n is an integer of at least 1; and
the wavy line (˜˜˜) indicates the point of attachment to other repeating units of Formula (I), and

contacting the hydrogel with an anode structure comprising an element selected from the group consisting of group 1, group 2, group 8, group 12 and group 13 of the Periodic Table of Elements; and a cathode structure comprising a catalyst; wherein the hydrogel is located between the anode structure and the cathode structure.

In an embodiment, the providing step of the hydrogel may comprise the steps of:
irradiating a solution of an acrylic monomer, a cross-linking agent and a polymerization initiator to form a film; and
contacting said film with an aqueous solution comprising a base having a formula MOH

In a specific embodiment, the hydrogel may be formed by:
dissolving the acrylic monomer in water that is substantially free of dissolved gases, to form solution A;
dissolving a cross-linking agent and a polymerization initiator in water, to form solution B;
contacting solution A and solution B to form a mixture C;
pouring mixture C onto a surface to form a film;
irradiating the film with ultraviolet radiation;
drying the film; and
contacting the dried film with an aqueous solution comprising a base having a formula MOH.

Advantageously, the method of manufacturing the electrochemical cell is straight forward and simple, and the method for providing the hydrogel only requires a single monomer. More advantageously, the components of the electrochemical cell may be easily assembled.

In another aspect, there is provided the use of a hydrogel comprising water and a cross-linked polymer having repeating units of the following formula (I) in a metal/air battery:

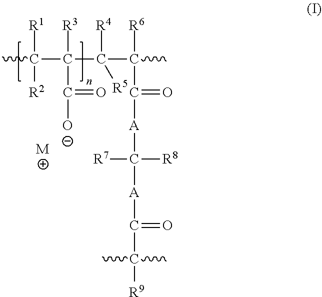

wherein A is selected from the group consisting of —NH—, —C(O)O—, —OC(O)—, and —C(O)NR¹⁰C(O)—;

R¹, R², R³, R⁴, R⁵, R⁶, R⁷, R⁸, R⁹ and R¹⁰ are independently selected from the group consisting of hydrogen, optionally substituted alkyl, optionally substituted alkenyl and optionally substituted alkenyl;

M is an alkali metal;

n is an integer of at least 1; and

the wavy line (˜˜˜) indicates the point of attachment to other repeating units of Formula (I).

Advantageously, the hydrogel may be useful in Zn/air batteries that display superior discharge and cycling ability. In addition, the hydrogel may be useful in a bendable Zn/air batteries, as the hydrogel is not liquid, but solid-state, therefore avoiding issues with displacement of the liquid electrolyte in the electrochemical cell.

In another aspect, there is provided a method for synthesizing a hydrogel comprising water and a cross-linked polymer having repeating units of the following formula (I):

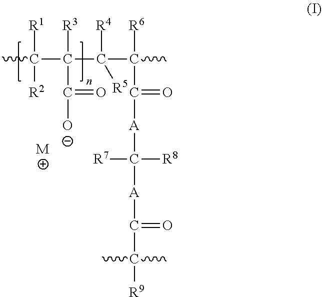

wherein A is selected from the group consisting of —NH—, —C(O)O—, —OC(O)—, and —C(O)NR¹⁰C(O)—,
R¹, R², R³, R⁴, R⁵, R⁶, R⁷, R⁸, R⁹ and R¹⁰ are independently selected from the group consisting of hydrogen, optionally substituted alkyl, optionally substituted alkenyl and optionally substituted alkenyl;
M is an alkali metal;
n is an integer of at least 1; and
the wavy line (˜˜˜) indicates the point of attachment to other repeating units of Formula (I),
wherein the providing step comprises the steps of: irradiating a solution of an acrylic monomer, a cross-linking agent and a polymerization initiator to form a film; and
contacting said film with an aqueous solution comprising a base having a formula MOH.

In another aspect, there is provided a hydrogel obtainable by the method as defined above.

Definitions

The following words and terms used herein shall have the meaning indicated:

“Current collector” for the purposes of this disclosure, refers to a material that receives electrons from generated by a catalyst, thereby providing a conducting path to the external circuit and minimising resistance of the electrochemical cell.

“Alkyl” as a group or part of a group refers to a straight or branched aliphatic hydrocarbon group, preferably a C₁-C₅₀ alkyl, preferably a C₁-C₁₂ alkyl, more preferably a C₁-C₁₀ alkyl, most preferably C₁-C₆ unless otherwise noted. Examples of suitable straight and branched C₁-C₆ alkyl substituents include methyl, ethyl, n-propyl, 2-propyl, n-butyl, sec-butyl, t-butyl, hexyl, and the like. The group may be a terminal group or a bridging group.

“Alkenyl” as a group or part of a group denotes an aliphatic hydrocarbon group containing at least one carbon-carbon double bond and which may be straight or branched preferably having 2-12 carbon atoms, more preferably 2-10 carbon atoms, most preferably 2-6 carbon atoms, in the normal chain. The group may contain a plurality of double bonds in the normal chain and the orientation about each is independently E or Z. Exemplary alkenyl groups include, but are not limited to, ethenyl, propenyl, butenyl, pentenyl, hexenyl, heptenyl, octenyl and nonenyl. The group may be a terminal group or a bridging group.

“Alkynyl” as a group or part of a group means an aliphatic hydrocarbon group containing a carbon-carbon triple bond and which may be straight or branched preferably having from 2-12 carbon atoms, more preferably 2-10 carbon atoms, more preferably 2-6 carbon atoms in the normal chain. Exemplary structures include, but are not limited to, ethynyl and propynyl. The group may be a terminal group or a bridging group.

The term “optionally substituted” as used herein means the group to which this term refers may be unsubstituted, or unless otherwise specified, may be substituted with one or more groups independently selected from hydrogen, halogen, optionally substituted alkyl, optionally substituted alkenyl, optionally substituted alkynyl, optionally substituted acyl, optionally substituted amine, optionally substituted acylamino, hydroxyl, optionally substituted alkyloxy, optionally substituted cycloalkyl, optionally substituted heterocycloalkyl, optionally substituted aryl, optionally substituted heteroaryl, or any mixture thereof.

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### DETAILED DISCLOSURE OF OPTIONAL EMBODIMENTS

There is provided an electrochemical cell comprising:
an anode structure comprising an element selected from the group consisting of group 1, group 2, group 8, group 12 and group 13 of the Periodic Table of Elements;
a cathode structure comprising a catalyst; and
a hydrogel located between the anode structure and the cathode structure, wherein the hydrogel comprises water and a cross-linked polymer having repeating units of the following formula (I):

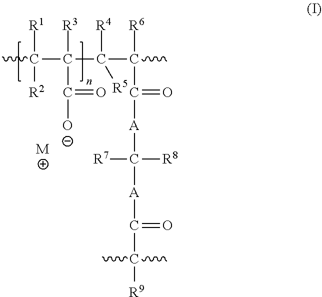

wherein A is selected from the group consisting of —NH—, —C(O)O—, —OC(O)—, and —C(O)NR¹⁰C(O)—,
R¹, R², R³, R⁴, R⁵, R⁶, R⁷, R⁸, R⁹ and R¹⁰ are independently selected from the group consisting of hydrogen, optionally substituted alkyl, optionally substituted alkenyl and optionally substituted alkenyl;
M is an alkali metal;
n is an integer of at least 1; and
the wavy line (˜˜˜) indicates the point of attachment to other repeating units of Formula (I).

There is provided an electrochemical cell comprising:
an anode structure comprising an element selected from the group consisting of group 1, group 2, group 8, group 12 and group 13 of the Periodic Table of Elements;
a cathode structure comprising a catalyst; and
a hydrogel located between the anode structure and the cathode structure, wherein the hydrogel comprises water and a cross-linked polymer having repeating units of the following formula (Ia):

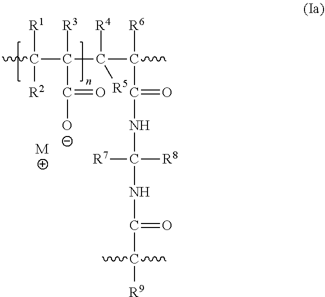

wherein R¹, R², R³, R⁴, R⁵, R⁶, R⁷, R⁸ and R⁹ are independently selected from the group consisting of hydrogen, optionally substituted alkyl, optionally substituted alkenyl and optionally substituted alkenyl;
M is an alkali metal;
n is an integer of at least 1; and
the wavy line (˜˜˜) indicates the point of attachment to other repeating units of Formula (I).

n may be an integer of at least 1. n may be an integer between 1 and 5. n may be an integer selected from the group consisting of 1, 2, 3, 4 and 5.

The number of repeating units of formula (I) or formula (Ia) in the cross-linked polymer may be in the range of 50 to 50,000, and the degree of cross-linking may be in the range of 20 mol % to 80 mol %. It is to be appreciated that for each repeating unit, the selection of the groups A, M, R¹, R², R³, R⁴, R⁵, R⁶, R⁷, R⁸, R⁹, R¹⁰, and n (for Formula (I)) or for M, R¹, R², R³, R⁴, R⁵, R⁶, R⁷, R⁸, R⁹ and n (for Formula (Ia)) may be the same or different.

The number of repeating units may be in the range of about 50 to about 50,000, about 50 to about 100, about 50 to about 500, about 50 to about 1000, about 50 to about 5000, about 50 to about 10,000, about 100 to about 500, about 100 to about 1000, about 100 to about 5000, about 100 to about 10,000, about 100 to about 50,000, about 500 to about 1000, about 500 to about 5000, about 500 to about 10,000, about 500 to about 50,0000, about 1000 to about 5000, about 1000 to about 10,000, about 1000 to about 50,000, about 5000 to about 10,000 about 5000 to about 50,000 or about 10,000 to about 50,000.

The degree of cross linking may be in the range of about 20 mol % to about 80 mol %, about 20 mol % to about 40 mol %, about 20 mol % to about 60 mol %, about 40 mol % to about 60 mol %, about 40 mol % to about 80 mol % or about 60 mol % to about 80 mol %.

The repeating unit(s) of the crosslinked polymer may be partially hydrolysed or may be fully hydrolysed. In an embodiment, where a repeating unit is partially hydrolysed, the O⁻M⁺ portion of the repeating unit may be —NH₂; conversely if a repeating unit is fully hydrolysed, the repeating unit will have the structure shown in Formula (I) or (Ia). Hence, the crosslinked polymer may be made up of a number of partially hydrolysed repeating units together with fully hydrolysed repeating units. Alternatively, the crosslinked polymer may be made up of all fully hydrolysed repeating units.

The hydrogel may comprise about 15 wt % to about 50 wt % of water based on the total weight of the hydrogel. The hydrogel may comprise about 15 wt % to about 17 wt %, about 15 wt % to about 30 wt %, about 15 wt % to about 45 wt %, about 17 wt % to about 30 wt %, about 17wt % to about 45 wt %, about 17 wt % to about 50 wt %, about 30 wt % to about 45 wt %, about 30 wt % to about 50 wt % or about 45 wt % to about 50 wt % of water based on the total weight of the hydrogel.

The element in the anode structure may be selected from the group consisting of lithium, sodium, potassium, rubidium, cesium, beryllium, magnesium, calcium, strontium, barium, iron, ruthenium, osmium, zinc, cadmium, mercury, aluminium, gallium, indium and thallium.

The element in the anode structure may be selected from the group consisting of zinc, aluminium, iron, magnesium and lithium.

The cathode structure comprising a catalyst may further comprise a current collector or a binder.

The current collector may comprise a material selected from the group consisting of carbon, copper, stainless steel, titanium, nickel and any mixture thereof.

The current collector may comprise carbon or copper. The current collector may be a porous carbon layer. The current collector may be graphite. The current collector may be a porous carbon disc. The current collector may be a copper mesh. The copper mesh may be malleable, facilitating the current collector and electrochemical cell comprising the current collector to be flexible. The current collector may be a nickel foam. The current collector may be porous. The current collector may also serve as diffusion layer if it is porous.

The current collector may have a porosity in the range of about 50% to about 90%, about 50% to about 60%, about 50% to about 70%, about 50% to about 80%, about 60% to about 70%, about 60% to about 80%, about 60% to about 90%, about 70% to about 80%, about 70% to about 90%, or about 80% to about 90%.

The current collector may be highly conductive to facilitate efficient transfer of electrons, and at the same time be permeable to oxygen so that oxygen may reach the catalyst surface efficiently.

The current collector may be have a disk shape having a diameter in the range of about 10 mm to about 15 mm, about 10 mm to about 12.5 mm, or about 12.5 mm to about 15 mm.

The binder may be selected from the group consisting of a sulfonated tetrafluoroethylene copolymer, polytetrafluoroethylene and polyvinylidene fluoride. The sulfonated tetrafluoroethylene copolymer may be Nafion™.

The binder may function to keep the catalyst and cathode in contact during the charging and discharging process, while maintaining the conductivity of the electrode.

The catalyst may be a reductant. The reductant may be selected from a group consisting of cobalt oxide-carbon hybrid derived from cobalt acetate and polyacrylonitrile (PAN), cobalt (II) oxide, manganese (II) oxide, binary cobalt-manganese spinel oxides, binary cobalt-nickel spinel oxides, binary nickel-iron spinel oxides, binary cobalt-iron oxides, complex spinel oxides comprising an element selected from the group consisting of cobalt, manganese, iron, nickel, copper and any mixture thereof, perovskite oxides containing lanthanide and first-row transition metals, and perovskite oxides containing lanthanide, rare earth metals and first-row transition metals.

The catalyst may be selected from the group consisting of CoOₓ/C, Pt/C and Pd/C.

The catalyst may be a cobalt oxide-carbon hybrid derived from cobalt acetate and polyacrylonitrile (PAN) or CoOₓ/C, wherein x is a value between 1 and 1.5. x may be any value between 1 and 1.5. Typically x is 1 for CoO, and 1.3 for Co₃O₄. CoOₓ/C may be a hybrid nanofibre comprising cobalt acetate and polyacrylonitrile (PAN) which has been carbonised at a temperature above 850° C.

The electrochemical cell may further comprise a metal foam placed adjacent to the cathode structure on the opposite side to the polymer. The metal foam may function as a further current collector for the cathode. The metal foam may be a nickel foam.

R¹, R², R³, R⁴, R⁵, R⁶, R⁷, R⁸ and R⁹ may all be hydrogen.

M may be selected from the group consisting of sodium, potassium and lithium.

The electrochemical cell may be a battery. The electrochemical cell may be a zinc/air battery. A Zn/air battery is an open system where by the electrolyte is exposed to air at the cathode side, which is different to sealed batteries such as a Zn/Ni battery.

The electrochemical cell may be a capacitator.

Each of the components of the electrochemical cell may have a thickness in the range that a person skilled in the art would consider practical and effective for the electrochemical cell to function. The thickness of each of the components may be in the micrometer to centimeter range.

There is provided a method for manufacturing an electrochemical cell, the method comprising the steps of:
providing a hydrogel comprising water and a cross-linked polymer having repeating units of the following formula (I):

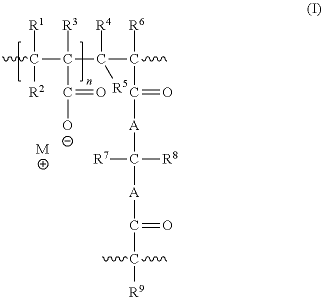

wherein A is selected from the group consisting of —NH—, —C(O)O—, —OC(O)—, and —C(O)NR¹⁰C(O)—,
wherein R¹, R², R³, R⁴, R⁵, R⁶, R⁷, R⁸, R⁹ and R¹⁰ are independently selected from the group consisting of hydrogen, optionally substituted alkyl, optionally substituted alkenyl and optionally substituted alkenyl;
M is an alkali metal;
n is an integer of at least 1; and
the wavy line (˜˜˜) indicates the point of attachment to other repeating units of Formula (I), and
contacting the hydrogel with an anode structure comprising an element selected from the group consisting of group 1, group 2, group 8, group 12 and group 13 of the Periodic Table of Elements; and a cathode structure comprising a catalyst; wherein the hydrogel is located between the anode structure and the cathode structure.

There is also provided a method for manufacturing an electrochemical cell, the method comprising the steps of:
providing a hydrogel comprising water and a cross-linked polymer having repeating units of the following formula (Ia):

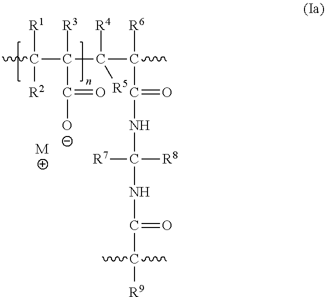

wherein R¹, R², R³, R⁴, R⁵, R⁶, R⁷, R⁸, and R⁹ are independently selected from the group consisting of hydrogen, optionally substituted alkyl, optionally substituted alkenyl and optionally substituted alkenyl;
M is an alkali metal;
n is an integer of at least 1; and
the wavy line (˜˜˜) indicates the point of attachment to other repeating units of Formula (I), and
contacting the hydrogel with an anode structure comprising an element selected from the group consisting of group 1, group 2, group 8, group 12 and group 13 of the Periodic Table of Elements; and a cathode structure comprising a catalyst; wherein the hydrogel is located between the anode structure and the cathode structure.

The providing step may comprise the steps of:
irradiating a solution of an acrylic monomer, a cross-linking agent and a polymerization initiator to form a film; and
contacting said film with an aqueous solution comprising a base having a formula MOH.

The irradiating step may comprise the steps of:
dissolving the acrylic monomer in water that is substantially free of dissolved gases, to form solution A;
dissolving the cross-linking agent and the polymerization initiator in water, to form solution B;
contacting solution A and solution B to form a mixture C;
pouring mixture C onto a surface to form a film; and
irradiating the film with ultraviolet radiation.

The method may further comprise the step of drying the film. The step of contacting the film with an aqueous solution comprising the base having the formula MOH may thus be undertaken after the step of drying the film, such that the step of contacting the film with the aqueous solution comprising the base having the formula MOH is undertaken on the dried film.

The crosslinked polymer before the step of contacting the film with an aqueous solution comprising the base may have a basic structure of the following:

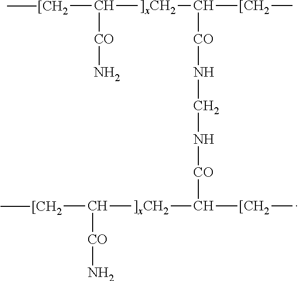

After the step of contacting the film with an aqueous solution comprising the base having the formula MOH, some or all of the —NH₂ groups in the cross-linked polymer may become hydrolysed. If all of the —NH₂ groups become hydrolyzed, then the repeating unit will have the structure shown in Formula (I) or (Ia). Hence, the crosslinked polymer that has been in contact with an aqueous solution comprising the base having the formula MOH may be made up of a number of partially hydrolysed repeating units together with fully hydrolysed repeating units. Alternatively, the crosslinked polymer may be made up of all fully hydrolysed repeating units.

Hence, in one specific embodiment, the steps involved in forming the cross-linked polymer having repeating units of formula (I) may be as follows:
dissolving the acrylic monomer in water that is substantially free of dissolved gases, to form solution A;
dissolving the cross-linking agent and the polymerization initiator in water, to form solution B;
contacting solution A and solution B to form a mixture C;
pouring mixture C onto a surface to form a film;
irradiating the film with ultraviolet radiation;
drying the film; and
contacting the dried film with an aqueous solution comprising a base having a formula MOH.

It is to be noted that the irradiation of the film may be undertaken when the film is being formed (that is during polymerization) or after the film is formed (that is, after polymerization).

The acrylic monomer may be present in solution A at a concentration in the range of about 5 wt % to 30 wt %, about 5 wt % to about 10 wt %, about 5 wt % to about 15 wt %, about 5 wt % to about 20 wt %, about 5 wt % to about 25 wt %, about 10 wt % to about 15 wt %, about 10 wt % to about 20 wt %, about 10 wt % to about 25 wt %, about 10 wt % to about 30 wt %, about 15 wt % to about 20 wt %, about 15 wt % to about 25 wt %, about 20 wt % to about 25 wt %, about 20 wt % to about 30 wt % or about 25 wt % to about 30 wt %. The acrylic monomer may be present in solution A at a concentration, preferably in the range of about 5 wt % to about 20 wt %.

Water that is substantially free of dissolved gases may be water that has been purged with nitrogen gas. The purging may be performed for a duration in the range of about 10 mins to about 20 mins, about 10 mins to about 15 mins or about 15 mins to about 20 mins.

The water may be deionized water.

The cross-linking agent may be present in solution B at a concentration in the range of about 0.02 wt % to about 1 wt %, 0.02 wt % to about 0.05 wt %, about 0.02 wt % to about 0.1 wt %, about 0.02 wt % to about 0.2 wt %, about 0.02 wt % to about 0.5 wt %, about 0.05 wt % to about 0.1 wt %, about 0.05 wt % to about 0.2 wt %, about 0.05 wt % to about 0.5 wt %, about 0.05 wt % to about 1 wt %, about 0.1 wt % to about 0.2 wt %, about 0.1 wt % to about 0.5 wt %, about 0.1 wt % to about 1 wt %, about 0.2 wt % to about 0.5 wt %, about 0.2 wt % to about 1 wt %, or about 0.5 wt % to about 1 wt %.

The polymerization initiator may be present in solution B at a concentration in the range of about 0.02 wt % to about 1 wt %, 0.02 wt % to about 0.05 wt %, about 0.02 wt % to about 0.1 wt %, about 0.02 wt % to about 0.2 wt %, about 0.02 wt % to about 0.5 wt %, about 0.05 wt % to about 0.1 wt %, about 0.05 wt % to about 0.2 wt %, about 0.05 wt % to about 0.5 wt %, about 0.05 wt % to about 1 wt %, about 0.1 wt % to about 0.2 wt %, about 0.1 wt % to about 0.5 wt %, about 0.1 wt % to about 1 wt %, about 0.2 wt % to about 0.5 wt %, about 0.2 wt % to about 1 wt %, or about 0.5 wt % to about 1 wt %.

Exposure to atmospheric air may be minimized during the contacting step between solution A and solution B. The exposure may be minimized by keeping solution B tightly capped until solution A is mixed with it.

The acrylic monomer may be selected from the group consisting of acrylamide, acrylamate, methacrylate, vinyl functionalized imide and any mixture thereof.

The cross-linking agent may be selected from the group consisting of N,N-methylenebisacrylamide, N,N-methylenebisacrylamide, N,N-(1,2-dihydroxyethylene)bisacrylamide, ethylene glycol diacrylate, di(ethyleneglycol)diacrylate, tetra(ethyleneglycol)diacrylate, ethylene glycol dimethacrylate, di(ethylene glycol) dimethacrylate, tri(ethylene glycol) dimethacrylate, and any mixture thereof.

The polymerization initiator may be selected from the group consisting of ammonium persulfate, hydroxymethanesulfinic acid, potassium persulfate and sodium persulfate.

The acrylic monomer may be acrylamide, the cross-linking agent may be N,N-methylenebisacrylamide and the polymerization initiator may be ammonium persulphate.

If the acrylic monomer is acrylamide, the cross-linking agent is N,N-methylenebisacrylamide the polymerization initiator is ammonium persulphate and MOH is KOH, then during the adsorption of the KOH into the polyacrylamide hydrogel, ammonia gas is liberated. Without being bound to theory, an ion-exchange reaction between the OH groups and NH₂ groups on the polyacrylamide may be occurring, which is supported by the reduction in the percentage of content of nitrogen after adsorption of the KOH.

The surface in the pouring step may be selected from the group consisting of glass, plastic, teflon or metal. The surface may be the surface of a petri dish. The surface may be stainless steel.

The irradiation may be performed for a duration in the range of about 30 mins to about 60 mins, about 30 mins to about 40 mins, about 30 mins to about 45 mins, about 30 mins to about 50 mins, about 40 mins to about 45 mins, about 40 mins to about 50 mins, about 50 mins to about 60 mins, about 45 mins to about 50 mins, about 45 mins to about 60 mins, or about 50 mins to about 60 mins.

The irradiation may be performed at a wavelength in the range of about 100 nm to about 400 nm, about 100 nm to about 150 nm, about 100 nm to about 200 nm, about 100 nm to about 250 nm, about 100 nm to about 300 nm, about 100 nm to about 350 nm, about 150 nm to about 200 nm, about 150 nm to about 250 nm, about 150 nm to about 300 nm, about 150 nm to about 350 nm, about 150 nm to about 400 nm, about 200 nm to about 250 nm, about 200 nm to about 300 nm, about 200 nm to about 350 nm, about 200 nm to about 400 nm, about 250 nm to about 300 nm, about 250 nm to about 350 nm, about 250 nm to about 400 nm, about 300 nm to about 350 nm, about 300 nm to about 400 nm, or about 350 nm to about 400 nm.

The irradiation step may cross-link the polymer in mixture C. Once the irradiation step is complete, the film may be removed from the surface.

The drying step may be performed at room temperature. If the drying step is performed at room temperature, then the duration of drying may be at least 9 hours. The drying step may be performed at a temperature in the range of about 70° C. to about 90° C. If the drying step is performed at about 80° C., then the duration of drying may be about 4 hours. The dried films may then be contacted with an aqueous solution comprising a base having a formula MOH. The base of formula MOH may be potassium hydroxide (KOH) or sodium hydroxide (NaOH).

The aqueous solution comprising a base may comprise about 0.5 wt % to 50 wt % of MOH, about 0.5 wt % to about 1 wt %, about 0.5 wt % to about 5 wt %, about 0.5 wt % to about 10 wt %, about 0.5 wt % to about 20 wt %, about 1 wt % to about 5 wt %, about 1 wt % to about 10 wt %, about 5 wt % to about 20 wt %, about 1 wt % to about 50 wt %, about 5 wt % to about 10 wt %, about 5 wt % to about 20 wt %, about 5 wt % to about 50 wt %, about 10 wt % to about 20 wt %, about 10 wt % to about 50 wt %, about 20 wt % to about 30 wt %, about 20 wt % to about 40 wt %, about 30 wt % to about 40 wt %, about 30 wt % to about 50 wt %, or about 40 wt % to about 50 wt % of MOH.

The aqueous solution comprising a base may comprise about 1M to about 8M MOH, about 1M to about 2M MOH., about 1M to about 4M MOH, about 1M to about 8M MOH, about 2M to about 4M MOH, about 2M to about 8M MOH, about 4M to about 6M MOH, about 6M to about 8M MOH. The aqueous solution comprising a base may comprise about 1M, about 2M, about 3M, about 4M, about 5M, about 6M, about 7M or about 8M of MOH.

The cathode structure comprising a catalyst may be prepared by dispersing a catalyst in a binder, and applying the mixture of the catalyst in the binder on a current collector. The mass loading of the catalyst may be in the range of about 8 mg cm⁻¹ to about 12 mg cm⁻¹, 8 mg cm⁻¹ to about 10 mg cm⁻¹ or about 10 mg cm⁻¹ to about 12 mg cm⁻¹.

The catalyst may be CoOₓ/C. The CoOₓ/C catalyst may be prepared by mixing polyacrylonitrile with cobalt acetate in dimethylformamide. The polyacrylonitrile may be present in a concentration in the range of about 8 wt % to about 12 wt %, about 8 wt % to about 10 wt % or about 10 wt % to about 12 wt %. The cobalt acetate may be present in a concentration in the range of about 1 wt % to about 3 wt %, about 1 wt % to about 2 wt % or about 2 wt % to about 3 wt %. The mixture may then be loaded into a syringe and expelled at a flow rate in the range of about 0.2 mL to about 2 mL per min, about 0.2 mL to about 0.3 mL per min, about 0.2 mL to about 0.5 mL per min, about 0.2 mL to about 1 mL per min, about 0.2 mL to about 1.5 mL per min, about 0.3 mL to about 0.5 mL per min, about 0.3 mL to about 1 mL per min, about 0.3 mL to about 1.5 mL per min, about 0.3 mL to about 2 mL per min, about 0.5 mL to about 1 mL per min, about 0.5 mL to about 1.5 mL per min, about 0.5 mL to about 2 mL per min, about 1 mL to about 1.5 mL per min, about 1 mL to about 2 mL per min or about 1.5 mL to about 2 mL per min.

The expelled mixture may be electrospun at a voltage in the range of about 5 kV to about 25 kV, about 5 kV to about 8 kV, about 5 kV to about 10 kV, about 5 kV to about 15 kV, about 5 kV to about 20 kV, about 8 kV to about 10 kV, about 8 kV to about 15 kV, about 8 kV to about 20 kV, about 8 kV to about 25 kV, about 10 kV to about 15 kV, about 10 kV to about 20 kV, about 10 kV to about 25 kV, about 15 kV to about 20 kV, about 15 kV to about 25 kV, or about 20 kV to about 25 kV. The distance between the needle and the receptacle for the expelled mixture during electrospinning may be in the range of about 5 cm to about 25 cm, about 5 cm to about 10 cm, about 5 cm to about 15 cm, about 5 cm to about 20 cm, about 10 cm to about 15 cm, about 10 cm to about 20 cm, about 10 cm to about 25 cm, about 15 cm to about 20 cm, about 15 cm to about 25 cm, or about 20 cm to about 25 cm.

The electrospun mixture was carbonized at a temperature of above about 850° C., about 900° C. or about 950° C. in a nitrogen atmosphere.

There is also provided the use of a hydrogel comprising water and a cross-linked polymer having repeating units of the following formula (I) in a metal/air battery:

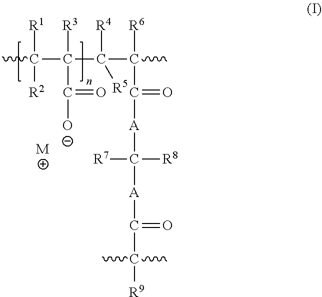

wherein A is selected from the group consisting of —NH—, —C(O)O—, —OC(O)—, —C(O)NR¹⁰C(O)—,

R¹, R², R³, R⁴, R⁵, R⁶, R⁷, R⁸, R⁹ and R¹⁰ are independently selected from the group consisting of hydrogen, optionally substituted alkyl, optionally substituted alkenyl and optionally substituted alkenyl;

M is an alkali metal;

n is an integer of at least 1; and

the wavy line (˜˜˜) indicates the point of attachment to other repeating units of Formula (I).

There is also provided use of a hydrogel comprising water and a cross-linked polymer having repeating units of the following formula (Ia) in a metal/air battery:

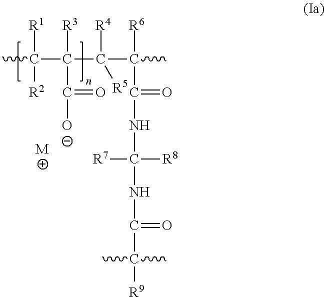

wherein R¹, R², R³, R⁴, R⁵, R⁶, R⁷, R⁸ and R⁹ are independently selected from the group consisting of hydrogen, optionally substituted alkyl, optionally substituted alkenyl and optionally substituted alkenyl;

M is an alkali metal;

n is an integer of at least 1; and

the wavy line (˜˜˜) indicates the point of attachment to other repeating units of Formula (I).

The metal in the metal/air battery may be an element selected from the group consisting of group 1, group 2, group 8, group 12 and group 13 of the Periodic Table of Elements. The metal/air battery may be a zinc/air battery.

There is also provided a method for synthesizing a hydrogel comprising water and a cross-linked polymer having repeating units of the following formula (I):

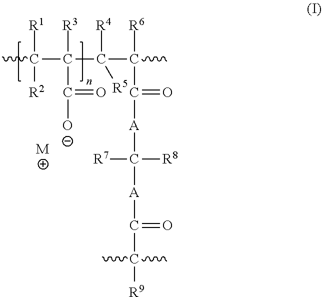

wherein A is selected from the group consisting of —NH—, —C(O)O—, —OC(O)—, —C(O)NR¹⁰C(O)—,
R¹, R², R³, R⁴, R⁵, R⁶, R⁷, R⁸, R⁹ and R¹⁰ are independently selected from the group consisting of hydrogen, optionally substituted alkyl, optionally substituted alkenyl and optionally substituted alkenyl;
M is an alkali metal;
n is an integer of at least 1; and
the wavy line (˜˜˜) indicates the point of attachment to other repeating units of Formula (I),
wherein the providing step comprises the steps of: irradiating a solution of an acrylic monomer, a cross-linking agent and a polymerization initiator to form a film; and
contacting said film with an aqueous solution comprising a base having a formula MOH.

There is also provided a method for synthesizing a hydrogel comprising water and a cross-linked polymer having repeating units of the following formula (Ia):

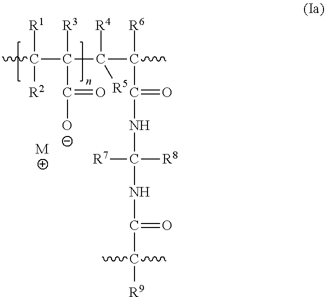

wherein R¹, R², R³, R⁴, R⁵, R⁶, R⁷, R⁸ and R⁹ are independently selected from the group consisting of hydrogen, optionally substituted alkyl, optionally substituted alkenyl and optionally substituted alkenyl;
M is an alkali metal;
n is an integer of at least 1; and
the wavy line (˜˜˜) indicates the point of attachment to other repeating units of Formula (I),
wherein the providing step comprises the steps of: irradiating a solution of an acrylamide monomer, a cross-linking agent and a polymerization initiator to form a film; and
contacting said film with an aqueous solution comprising a base having a formula MOH.

There is also provided a hydrogel obtainable by the method as defined above.

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIG. 1 is a schematic representation of the synthesis of free-standing alkaline polymer gel electrolytes (PGEs). Inset shows a sample of the free-standing alkaline PGE.

FIG. 2 refers to photographs showing a blank carbon paper disk ((A), pre-punched into a diameter of 12.5 mm) and 3 such disks after uniform loading by drop-casting with catalyst ink (B).

FIG. 3 shows the components of the CR2032 Zn/air coin battery assembly.

FIG. 4 refers to graphs showing the performance of Zn-ABs using free-standing PAM PGE films as electrolytes. (A) shows a typical polarization curve and corresponding power density plot of the battery, (B) shows the discharge performance at different currents, (C) shows the full discharge curve at a current of 2 mA and (D) shows the discharge/charge cycling data at a current of 2 mA.

FIG. 5 is a graph showing a comparison of the discharge volume of Zn-Air CR2032 cells using free standing PAM PGE (blue and black) and common PAA PGE (red), showing comparable performance in terms of the discharge voltage.

FIG. 6 refers to images of Zn-AB CR2032 cells using (A) PAM PGE and (B) PAA PGE, showing that the PAM PGE being a free-standing film, is able to retain its original geometry and does not displace under operating conditions, whereas PAA tends to “spill out” of the device.

FIG. 7 refers to images showing a large area Zn-AB cell used to power a small fan, in (A) flat geometry and (B) after bending.

FIG. 8 refers to a schematic illustration on how to fabricate a compressible/expandable Zn-AB cell. (A) shows the main components of the compressible/expandable Zn-AB cell, (B) shows the assembly of the battery using elastic sealant. (C) shows the assembled Zn-AB cell and (D) shows the side view of the battery at normal, compressed and expanded states.

### EXAMPLES

Non-limiting examples of the invention will be further described in greater detail by reference to specific Examples, which should not be construed as in any way limiting the scope of the invention.

### Example 1

### Materials

Polyacrylonitrile, cobalt acetate, dimethylformamide and zinc metal were obtained from Sigma-Aldrich of St. Louis, Mo. of the United States of America and was used without further purification. Carbon paper was obtained from SGL Carbon GmbH, Germany, and the Copper mesh and Nickel foam were obtained from Latech Scientific Supply Pte. Ltd., Singapore.

### Example 2

### Synthesis of the Polyacrylamide Polymer Gel Electrolyte (PAM PGE) Film

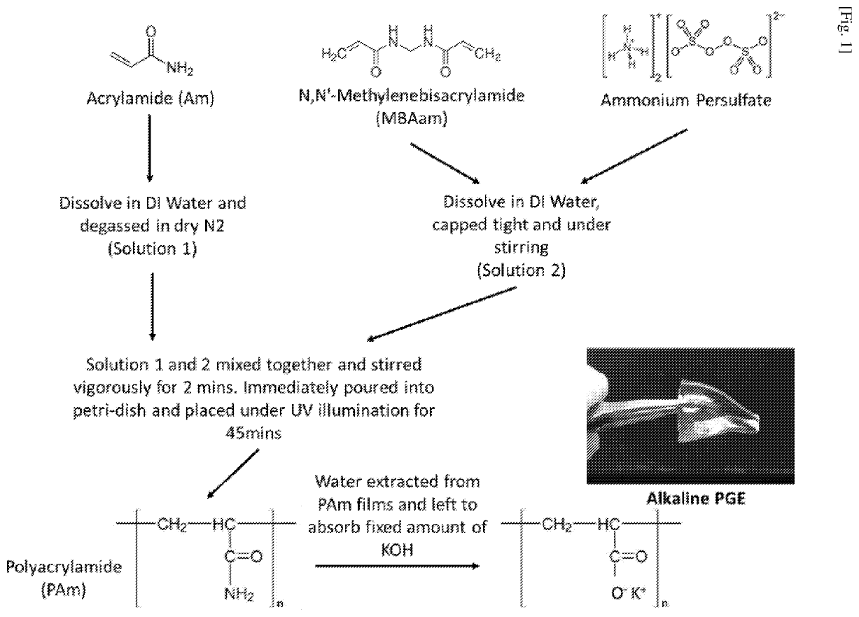

As shown in FIG. 1, briefly, acrylamide (2.5 g) was dissolved in deionised water (10 mL) and bubbled with dry N₂ gas for 15 minutes and this was labeled as Solution 1. N,N-Methylenebisacrylamide (MBAa) (5 mg) and ammonium persulphate (APS) (5 mg) were dissolved in deionised water (5 mL), capped tight and placed under stirring. This solution was labeled as Solution 2. After Solution 1 was bubbled with dry N₂ gas for 15 minutes, it was quickly added to Solution 2 to prevent excess exposure to atmospheric air. After stirring for another 2 minutes, the combined solution was poured onto a glass petri dish and placed under UV illumination for 45 minutes. Once the UV-initiated radical polymerisation was completed, the polyacrylamide (PAM) films were removed from the petri dish and free-standing hydrogel films were obtained. These PAM films were then allowed to dry at room temperature. The dried films were then placed in a closed container containing a fixed amount (6M) of KOH to allow for adsorption of KOH solution into the gel to produce free-standing alkaline PAM polymer gel electrolytes (PGEs).

### Example 3

### Preparation of a Catalyst Electrode

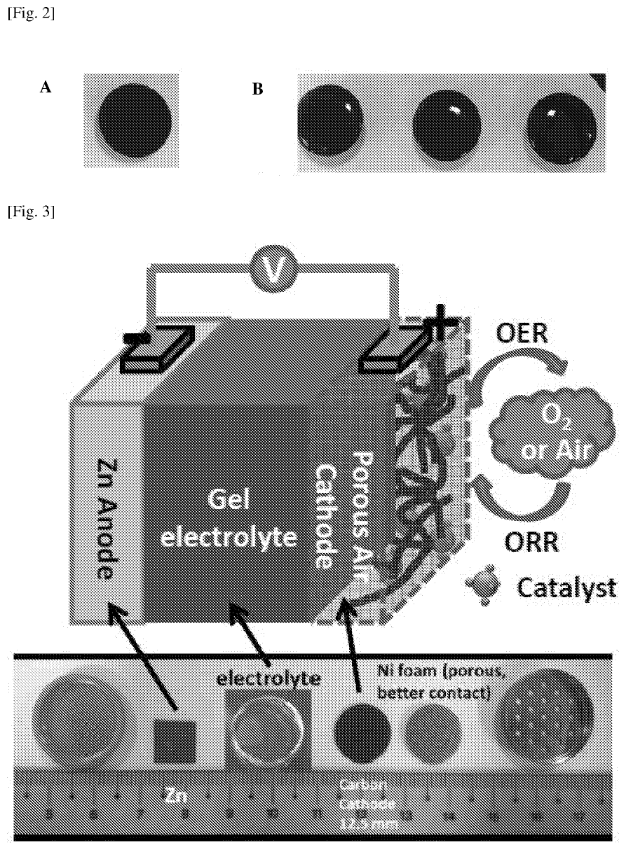

To prepare the catalyst electrode, a homogeneous catalyst ink solution was firstly prepared. The catalyst such as CoOₓ/C may be synthesized (refer further below for details) or commercially purchased such as Pt/C, but is not limited to the above two. Using the synthesized catalyst of CoOₓ/C as an example, 30 mg CoOₓ/C was dispersed in 5 mL water solution containing 600 μL Nafion solution (5 wt. % water solution, Sigma Aldrich of St. Louis, Mo., United States of America). After sonication for at least 30 minutes, an appropriate volume of such solution was then carefully dropped onto a current collector (carbon paper disk pre-punched with a diameter of 12.5 mm, as shown in FIG. 2A). A fixed volume of catalyst ink solution was uniformly casted onto the carbon paper disk to ensure equal distribution of catalyst as well as constant amount of catalyst loaded onto each carbon paper disk (FIG. 2B). In such a way, the mass loading of the catalyst was well controlled, for example 1.0 mg cm⁻², so that the catalyst electrodes prepared are identical and comparable.

CoOₓ/C catalyst was synthesised as follows:

A homogeneous polymer precursor containing 10 wt. % of polyacrylonitrile (PAN) and 2 wt. % of cobalt acetate was prepared in dimethylformamide (DMF). Then the precursor solution was loaded into a syringe with a 22-gauge blunt tip needle which was mounted onto a syringe pump to control the flow rate at 0.3-1.5 mL per minute. The electro-spinning process was conducted by applying a positive voltage of 8-20 kV between the needle and a grounded aluminium foil separated with a distance of 10-20 cm. The as-prepared electrospun fibres collected on the aluminium foil were heated and stabilized at 260° C. in air for 1 hour and consequently carbonized at 900° C. in nitrogen environment for another 1 hour. After being cooled to room temperature, the obtained black fibre materials were re-heated to 200° C. in air for 1.5 hours to obtain the final catalyst of CoOₓ/C.

### Example 4

### Fabricating a Coin-Cell Type Zn-AB

Zn/air coin cells of the CR2032 type were assembled with the components as shown in FIG. 3, together with the oxygen reduction reaction (ORR) and the oxygen evolution reaction (OER) in the presence of a catalyst.

The batteries were assembled with customized CR2032 coin cell, the cathode cover was drilled with small holes for air permission. Zn-air battery performance was evaluated on a battery tester of NEWARE BTS-610 (Shenzhen, China). All discharge tests and discharge-charge cycling tests were carried out at ambient air conditions (oxygen supplied only from environment, without additional oxygen).

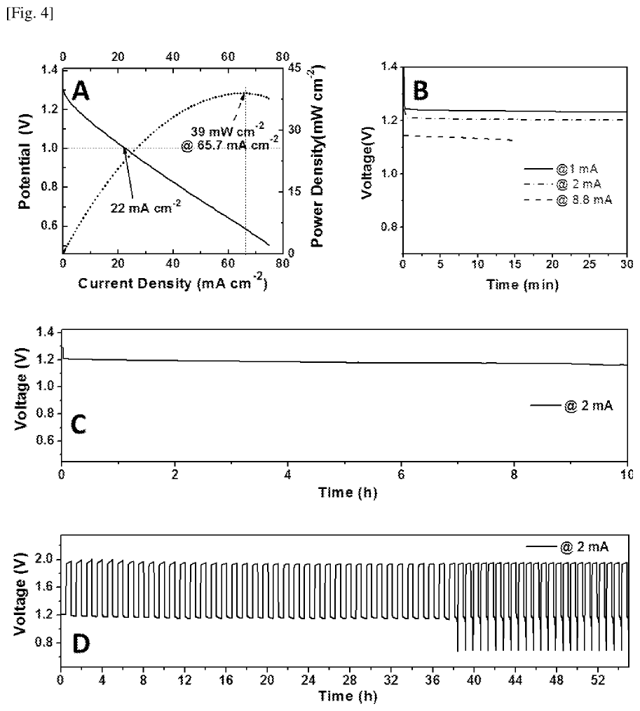

The cathode catalysts used were CoOₓ/C. The alkaline PAM PGEs were cut into desired disk shape before assembly, and subjected to discharge as well as discharge/charge cycling tests to evaluate battery performance. FIG. 4A shows the polarization and the corresponding power density curves of a typical Zn-AB using PAM PGE. At the discharging voltage of 1V, the battery delivers a current density of ˜22 mA cm⁻². The peak power density of the battery reaches 39 mW cm⁻² as it was discharged at 65.7 mA cm⁻². FIG. 4B demonstrates the ability of the fabricated Zn-AB to discharge smoothly at different currents. The decrease in the discharge voltage plateaus at higher discharge current density is attributed to the conventional polarization; in agreement with the results shown in FIG. 4A.

FIG. 4C shows the full discharge curve at a current of 2 mA. The fabricated battery is able to maintain a high and flat discharge voltage plateau at ˜1.2 V for ˜10.5 hours, corresponding to an energy capacity of 21 mAh. In this experiment, the cathode used was ˜1.23 cm², hence the specific areal capacity of the battery is estimated to be 17.1 mAh cm⁻² which is about 5 times higher than the highest areal capacity reported to date among all types of foldable energy-storage devices (3 mAh cm⁻²) as demonstrated by using Li—S type batteries. The alkaline PAM PGE of the present disclosure is intrinsically free standing and flexible which in principle allows fabrication of bendable or even foldable Zn-ABs with even higher specific areal capacities.

Besides good discharge capability and high specific areal capacity, the Zn-AB with PAM PGE also illustrates good cycling performance as shown in FIG. 4D, with no obvious voltage changes observed in both discharge and charge states after testing for more than 35 cycles.

### Example 5

### PAM PGE vs PAA PGE

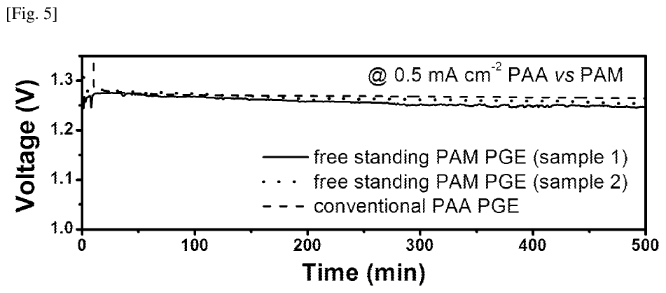

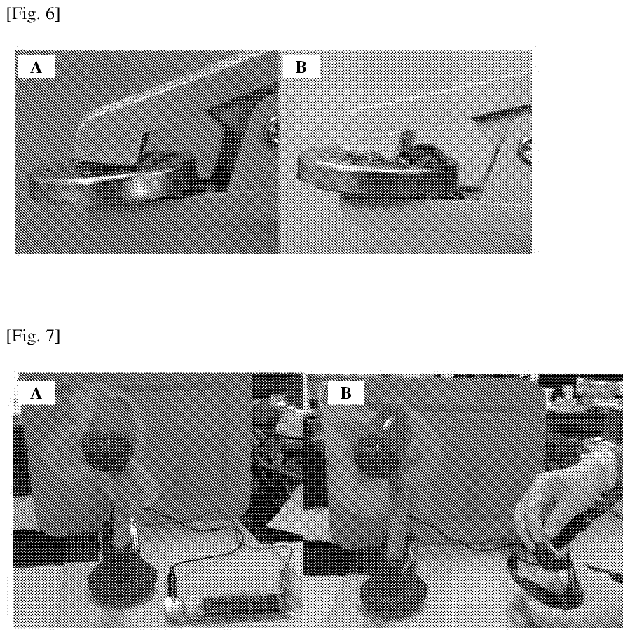

Preliminary benchmarking experiments using polyacrylic acid (PAA) instead of polyacrylamide (PAM) were carried out. PAA has been demonstrated to be an alkaline polymer gel electrolyte (PGE) before, but PAA exists in the form of a highly viscous fluid and is not a free-standing film. Zn/Air CR2032 cells with identical components (zinc plate as the anode and Pt/C as the cathode catalyst) were fabricated, where the only component difference was in the PGE used. The weight of the PGE used is kept constant for both PAA and PAM based cells. Discharge tests (FIG. 5) indicated that PAM PGEs derived according to the present disclosure exhibit similar performance to PAA PEGs in terms of voltage stability during discharge. Advantages of using PAM over PAA include the ease of handling and preparation (where it is easier to cut the PAM PGE film into the desired geometry as compared to manipulating the very viscous PAA fluid into the desired geometry) as well as the minimizing of gel protrusion from the cell under operation as indicated in FIG. 6. PAM PGE, being a free-standing film, is able to retain its original geometry and does not displace under operating conditions (FIG. 6A) whereas PAA tends to “spill out” of the device (FIG. 6B).

### Example 6

### Bendable Zn-AB

Next, utilising the advantages of free-standing and easy to handle properties of the PAM PGE, a larger PAM PGE film (approximately 2 cm×10 cm) was prepared for fabricating bendable Zn-AB. The battery was simply constructed by using a zinc sheet as the anode, a free standing PAM film as the gel electrolyte, CoOₓ/C powder deposited directly on the PAM as the catalyst and a copper mesh was employed as the current collector for forming a cathode (FIG. 7). As demonstrated, a small fan can be powered by a single cell regardless of whether the cell is in a flat state (FIG. 7A) or bent state (FIG. 7B). This cell was in fully solid state, and exhibited the ability to continuously power the small fan even in a bent state.

### Example 7

### Compressible/Expandable Zn-AB

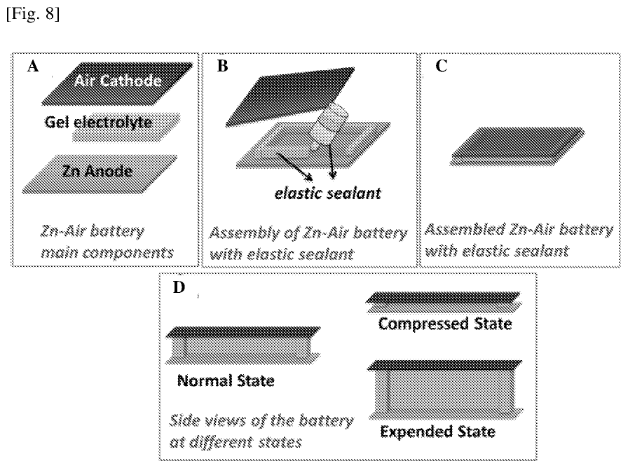

In future iterations, compressible/expandable Zn-AB cells will be fabricated according to the diagrams in FIG. 8. FIG. 8A shows the main components of the compressible/expandable Zn-AB cell, FIG. 8B shows the assembly of the battery using elastic sealant. FIG. 8C shows the assembled Zn-AB cell and FIG. 8D shows the side view of the battery at normal, compressed and expanded states.

Instead of using hard and rigid materials as the housing for Zn-AB cells, rubbery materials such as PDMS or silicone will be used as a defined casing for Zn-AB cells (FIG. 8B). As illustrated in FIG. 8D, the usage of elastic sealants confers compressibility as well as expandability to the Zn-AB cells. Furthermore, coupled with the flexibility of our free-standing alkaline PGE, a truly flexible electrochemical cell will be devised which can be applied to applications such as wearable technologies.

### INDUSTRIAL APPLICABILITY

The disclosed electrochemical cell may be useful in energy storage. The disclosed electrochemical device may be useful as an alternative to existing aqueous electrolytes for use in safer batteries. The disclosed electrochemical cell may have applications in wearable technology, particularly in consumer products such as watches, eye glasses and textiles, in monitoring healthcare equipment, such as in data acquisition and communication, and in medical devices such as drug delivery devices, for example for insulin injection.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1-27. (canceled)

28. An electrochemical cell comprising:
an anode structure comprising an element selected from the group consisting of group 1, group 2, group 8, group 12 and group 13 of the Periodic Table of Elements;
a cathode structure comprising a catalyst; and
a hydrogel located between the anode structure and the cathode structure, wherein the hydrogel comprises water and a cross-linked polymer having repeating units of the following formula (I): 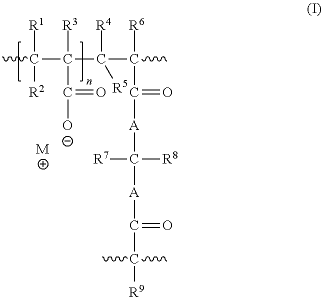
wherein A is selected from the group consisting of —NH—, —C(O)O—, —OC(O)—, and —C(O)NR¹⁰C(O)—;
R¹, R², R³, R⁴, R⁵, R⁶, R⁷, R⁸, R⁹ and R¹⁰ are independently selected from the group consisting of hydrogen, optionally substituted alkyl, and optionally substituted alkenyl;
M is an alkali metal;
n is an integer of at least 1; and
the wavy line (˜˜˜) indicates the point of attachment to other repeating units of Formula (I),
wherein the degree of cross-linking in the cross-linked polymer is in the range of 20 mol % to 80 mol %.

29. The electrochemical cell according to claim 28, wherein the number of repeating units of formula (I) in the cross-linked polymer is in the range of 50 to 50,000.

30. The electrochemical cell according to claim 28, wherein the element in the anode structure is selected from the group consisting of zinc, aluminium, iron, magnesium and lithium.

31. The electrochemical cell according to claim 28, wherein the catalyst is a reductant selected from a group consisting of cobalt oxide-carbon hybrid derived from cobalt acetate and polyacrylonitrile (PAN), cobalt (II) oxide, manganese (II) oxide, binary cobalt-manganese spinel oxides, binary cobalt-nickel spinel oxides, binary nickel-iron spinel oxides, binary cobalt-iron oxides, complex spinel oxides comprising an element selected from the group consisting of cobalt, manganese, iron, nickel, copper and any mixture thereof, perovskite oxides containing lanthanide and first-row transition metals, and perovskite oxides containing lanthanide, rare earth metals and first-row transition metals.

32. The electrochemical cell according to claim 31, wherein the catalyst is a cobalt oxide-carbon hybrid derived from cobalt acetate and polyacrylonitrile (PAN) or CoOₓ/C, wherein x is a value between 1 and 1.5.

33. The electrochemical cell according to claim 28, wherein the cathode structure further comprises a current collector or a binder.

34. The electrochemical cell according to claim 33, wherein the current collector comprises a material selected from the group consisting of carbon, copper, stainless steel, titanium, nickel and any mixture thereof or is porous.

35. The electrochemical cell according to claim 33, wherein the binder is selected from the group consisting of a sulfonated tetrafluoroethylene copolymer, polytetrafluoroethylene and polyvinylidene fluoride.

36. The electrochemical cell according to claim 28, wherein R¹, R², R³, R⁴, R⁵, R⁶, R⁷, R⁸ and R⁹ are all hydrogen or wherein M is selected from the group consisting of sodium, potassium and lithium.

37. The electrochemical cell according to claim 28, wherein the electrochemical cell is a battery.

38. The electrochemical cell according to claim 28, wherein the electrochemical cell is a capacitator.

39. A method for manufacturing an electrochemical cell, the method comprising the operations of:
providing a hydrogel comprising water and a cross-linked polymer having repeating units of the following formula (I): 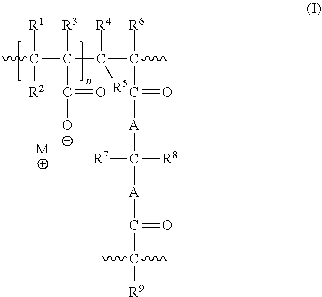
wherein A is selected from the group consisting of —NH—, —C(O)O—, —OC(O)—, and —C(O)NR¹⁰C(O)—;
R¹, R², R³, R⁴, R⁵, R⁶, R⁷, R⁸, R⁹ and R¹⁰ are independently selected from the group consisting of hydrogen, optionally substituted alkyl, and optionally substituted alkenyl;
M is an alkali metal;
n is an integer of at least 1; and
the wavy line (˜˜˜) indicates the point of attachment to other repeating units of Formula (I),
wherein the degree of cross-linking in the cross-linked polymer is in the range of 20 mol % to 80 mol %, and
contacting the hydrogel with an anode structure comprising an element selected from the group consisting of group 1, group 2, group 8, group 12 and group 13 of the Periodic Table of Elements; and a cathode structure comprising a catalyst; wherein the hydrogel is located between the anode structure and the cathode structure.

40. The method according to claim 39, wherein the providing operation comprises the operations of:
irradiating a solution of an acrylic monomer, a cross-linking agent and a polymerization initiator to form a film; and contacting said film with an aqueous solution comprising a base having a formula MOH.

41. The method according to claim 40, wherein the irradiating operation comprises the operations of:
dissolving said acrylic monomer in water that is substantially free of dissolved gases, to form solution A;
dissolving said cross-linking agent and polymerization initiator in water, to form solution B;
contacting solution A and solution B to form a mixture C;
pouring mixture C onto a surface to form a film; and
irradiating the film with ultraviolet radiation, or further comprising the operation of drying the film.

42. The method according to claim 41, wherein the acrylic monomer is present in solution A at a concentration in the range of 5 wt % to 20 wt %.

43. The method according to claim 41, wherein the cross-linking agent is present in solution B at a concentration in the range of 0.02 wt % to 1 wt %, and the polymerization initiator is present in solution B at a concentration in the range of 0.02 wt % to 1 wt %.

44. The method according to claim 40, wherein the acrylic monomer is acrylamide, the cross-linking agent is N,N-methylenebisacrylamide and the polymerization initiator is ammonium persulphate.

45. The method according to claim 40, wherein the irradiating operation is performed for a duration in the range of 30 mins to 60 mins or
wherein the drying operation is performed at room temperature.

46. The method according to claim 40, wherein the aqueous solution comprising a base comprises 0.5 wt % to 50 wt % MOH.

47. A method for synthesizing a hydrogel comprising water and a cross-linked polymer having repeating units of the following formula (I): 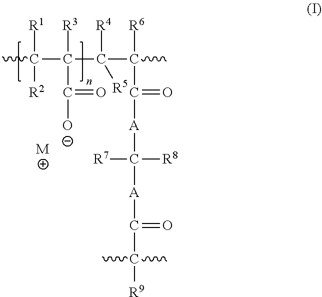
wherein A is selected from the group consisting of —NH—, —C(O)O—, —OC(O)—, and —C(O)NR¹⁰C(O)—,
R¹, R², R³, R⁴, R⁵, R⁶, R⁷, R⁸, R⁹ and R¹⁰ are independently selected from the group consisting of hydrogen, optionally substituted alkyl, and optionally substituted alkenyl;
M is an alkali metal;
n is an integer of at least 1;
the wavy line (˜˜˜) indicates the point of attachment to other repeating units of Formula (I); and
the degree of cross-linking in the cross-linked polymer is in the range of 20 mol % to 80 mol %,
wherein the providing operation comprises the operations of:
irradiating a solution of an acrylic monomer, a cross-linking agent and a polymerization initiator to form a film; and
contacting said film with an aqueous solution comprising a base having a formula MOH.
